(19) United States
(12) Patent Application Publication
(10) Pub. No.: US 2025/0188370 A1
(43) Pub. Date: Jun. 12, 2025

(54) METHODS FOR PROCESSING LIQUID ORGANIC HYDROGEN CARRIERS

(71) Applicant: Saudi Arabian Oil Company, Dhahran (SA)

(72) Inventors: Raed H. Abudawoud, Dhahran (SA); Guanghui Zhu, Dhahran (SA); Anas S. Al-Aqeeli, Dhahran (SA); Faisal M. Almulla, Dhahran (SA)

(73) Assignee: Saudi Arabian Oil Company, Dhahran (SA)

(21) Appl. No.: 18/536,687

(22) Filed: Dec. 12, 2023

(51) Int. Cl. C10G 49/00

(52) U.S. Cl. CPC C10G 49/007

(57) ABSTRACT

One or more liquid organic hydrogen carriers may be processed by a method that may include introducing a hydrotreater feed including one or more hydrogen-diminished liquid organic hydrogen carriers, a naphtha feed, and hydrogen gas into a naphtha hydrotreater to form a hydrotreated effluent. In the naphtha hydrotreater, the one or more hydrogen-diminished liquid organic hydrogen carriers and hydrogen gas may react to form one or more hydrogen-rich liquid organic hydrogen carriers, and the naphtha feed reacts to form a hydrotreated naphtha. The method may include passing the hydrotreated effluent from the naphtha hydrotreater to a separation unit, wherein the hydrotreated effluent includes the one or more hydrogen-rich liquid organic hydrogen carriers, the hydrotreated naphtha, and unreacted hydrogen. The method may further comprise, in the separation unit, separating at least the one or more hydrogen-rich liquid organic hydrogen carriers from the hydrotreated naphtha.

### TECHNICAL FIELD

Embodiments of the present disclosure generally relate to chemical processing and, more specifically, to processes and systems utilized to process liquid organic hydrogen carriers.

### BACKGROUND

The demand for hydrogen is currently experiencing a significant upswing driven by its critical role in addressing global energy and environmental challenges. With a growing emphasis on decarbonization and reducing greenhouse gas emissions, hydrogen is sought after as a clean and versatile energy carrier. It is increasingly used in sectors like transportation, industry, and power generation to replace fossil fuels and reduce carbon footprints. The demand is particularly pronounced in the development of fuel cell vehicles and the integration of hydrogen into industrial processes, including the production of steel and chemicals. Furthermore, hydrogen's potential for energy storage and grid stabilization, particularly when coupled with renewable energy sources, has bolstered its appeal. As nations worldwide commit to ambitious sustainability targets, the current demand for hydrogen reflects its pivotal role in achieving a greener and more sustainable energy future.

### SUMMARY

Shipping and storing hydrogen presents several challenges for its effective utilization as a clean energy carrier. One of the primary issues is its low energy density by volume, which means that a substantial volume of hydrogen needs to be transported to meet energy demands. Hydrogen is also highly flammable. Additionally, leakage can be a concern, as hydrogen's small molecular size makes it prone to escaping storage and transport containers. However, the presently disclosed embodiments utilize liquid organic hydrogen carriers (LOHCs) that can effectively store and transport hydrogen, releasing it when needed through chemical processes, thus enabling a practical and efficient means of utilizing hydrogen as an energy source. In particular, in the embodiments disclosed herein, charging of LOHCs is integrated with naphtha hydrotreating, a process that may be utilized in a crude oil refinery, but hydrogenating LOHCs in a naphtha hydrotreater that is hydroprocessing a naphtha feed. Specifically, it has been discovered that the integration of LOHC charging and naphtha hydrotreating may have synergistic effects since the hydrogenation of the LOHC and the naphtha hydrotreating may take place at relatively similar temperatures and pressures, such that they may be co-fed to the same reactor. Additionally, in one or more embodiments, the charged LOHCs may be easily separable from the hydrotreated naphtha following charging of the LOHC. These aspects allow for integration of LOHC charging with naphtha hydrotreating, reducing both capital and operating expenditures.

According to one or more embodiments, a method for processing one or more liquid organic hydrogen carriers may comprise introducing a hydrotreater feed comprising one or more hydrogen-diminished liquid organic hydrogen carriers, a naphtha feed, and hydrogen gas into a naphtha hydrotreater to form a hydrotreated effluent. In the naphtha hydrotreater, the one or more hydrogen-diminished liquid organic hydrogen carriers and hydrogen gas may react to form one or more hydrogen-rich liquid organic hydrogen carriers, and the naphtha feed may react to form a hydrotreated naphtha. The method may further comprise passing the hydrotreated effluent from the naphtha hydrotreater to a separation unit, wherein the hydrotreated effluent may comprise the one or more hydrogen-rich liquid organic hydrogen carriers, the hydrotreated naphtha, and unreacted hydrogen. The method may further comprise, in the separation unit, separating at least the one or more hydrogen-rich liquid organic hydrogen carriers from the hydrotreated naphtha.

These and other embodiments are described in more detail in the Detailed Description. It is to be understood that both the foregoing general description and the following detailed description present embodiments of the subject technology, and are intended to provide an overview or framework for understanding the nature and character of the described technology as it is claimed. The accompanying drawings are included to provide a further understanding of the presently disclosed technology and are incorporated into and constitute a part of this specification. The drawings illustrate various embodiments and, together with the description, serve to explain the principles and operations of the presently described technology. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a diagram of a liquid organic hydrogen processing system, according to one or more embodiments described in this disclosure; and

FIG. 2 schematically depicts a diagram of another liquid organic hydrogen processing system, according to one or more embodiments described in this disclosure.

Reference will now be made in greater detail to various embodiments, some embodiments of which are illustrated in the accompanying drawings. Whenever possible, the same reference numerals will be used throughout the drawings to refer to the same or similar parts.

For the purpose of describing the simplified schematic illustrations and descriptions of the relevant figures, the numerous valves, temperature sensors, electronic controllers and the like that may be employed and well known to those of ordinary skill in the art of certain chemical processing operations are not included. Further, accompanying components that are often included in typical chemical processing operations, such as air supplies, catalyst hoppers, and flue gas handling systems, are not depicted. Accompanying components that are in hydrotreating units, such as bleed streams, spent catalyst discharge subsystems, and catalyst replacement sub-systems are also not shown. It should be understood that these components are within the spirit and scope of the present embodiments disclosed. However, operational components, such as those described in the present disclosure, may be added to the embodiments described in this disclosure.

It should further be noted that arrows in the drawings refer to process streams. However, the arrows may equivalently refer to transfer lines which may serve to transfer process streams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows which do not connect two or more system components signify a product stream which exits the depicted system or a system inlet stream which enters the depicted system. Product streams may be further processed in accompanying chemical processing systems or may be commercialized as end products. System inlet streams may be streams transferred from accompanying chemical processing systems or may be non-processed feedstock streams. Some arrows may represent recycle streams, which are effluent streams of system components that are recycled back into the system. However, it should be understood that any represented recycle stream, in some embodiments, may be replaced by a system inlet stream of the same material, and that a portion of a recycle stream may exit the system as a system product.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component. It should be understood that arrows in the relevant figures are not indicative of necessary or essential steps.

It should be understood that according to the embodiments presented in the relevant figures, an arrow between two system components may signify that the stream is not processed between the two system components. In other embodiments, the stream signified by the arrow may have substantially the same composition throughout its transport between the two system components. Additionally, it should be understood that in one or more embodiments, an arrow may represent that at least 75 wt. %, at least 90 wt. %, at least 95 wt. %, at least 99 wt. %, at least 99.9 wt. %, or even 100 wt. % of the stream is transported between the system components. As such, in some embodiments, less than all of the streams signified by an arrow may be transported between the system components, such as if a slip stream is present.

It should be understood that two or more process streams are “mixed” or “combined” when two or more lines intersect in the schematic flow diagrams of the relevant figures. Mixing or combining may also include mixing by directly introducing both streams into a like reactor, separation device, or other system component. For example, it should be understood that when two streams are depicted as being combined directly prior to entering a separation unit or reactor, that in some embodiments the streams could equivalently be introduced into the separation unit or reactor and be mixed in the reactor.

### DETAILED DESCRIPTION

The present disclosure is directed to methods of processing one or more liquid organic hydrogen carriers (LOHCs) in an integrated system with naphtha hydrotreating. Generally, in the embodiments described herein, a hydrogen-diminished LOHC may be co-fed to a naphtha hydrotreater with naphtha and hydrogen gas. The hydrogen-diminished LOHC, hydrogen gas, and naphtha feed may contact each other under conditions sufficient to produce a hydrotreated effluent comprising hydrogen-rich LOHC, hydrotreated naphtha, an unreacted hydrogen. In such embodiments, it has been discovered that the hydrotreatment of naphtha and hydrogenation of a hydrogen-diminished LOHC may occur in the presence of the same catalyst under the same temperature and pressure conditions. Additionally, the difference in boiling points between the produced hydrotreated naphtha and the hydrogen-rich LOHC products have sufficiency different boiling points, allowing for efficient separation. The hydrotreated naphtha may be passed downstream for further processing and the hydrogen-rich LOHC may be transported to a facility where the hydrogen gas can be recovered by dehydrogenation.

As described herein, a “naphtha hydrotreater” generally refers to a unit within a refinery designed to perform the hydrotreating process on naphtha fractions. Naphtha is a hydrocarbon feedstock with a wide boiling range and is commonly used for producing gasoline, petrochemicals, and other high-value products, as is understood by those skilled in the art. As described herein, naphtha may be heavy naphtha, light naphtha, or any cut of naphtha. In some embodiments, the naphtha may be heavy naphtha and may have a minimum boiling point in a range of from 80° C. to 100° C. and a maximum boiling point in a range of from 180° C. to 220° C. The naphtha hydrotreater generally aims to remove impurities and contaminants, such as sulfur, nitrogen, and/or olefins, from the naphtha by subjecting it to high-temperature, high-pressure conditions in the presence of hydrogen and a hydrotreating catalyst.

As used in this disclosure, a “separation unit” refers to any separation device or system of separation devices that at least partially separates one or more chemicals that are mixed in a process stream from one another. For example, a separation unit may selectively separate differing chemical species, phases, or sized material from one another, forming one or more chemical fractions. Examples of separation units include, without limitation, distillation columns, flash drums, knock-out drums, knock-out pots, centrifuges, cyclones, filtration devices, traps, scrubbers, expansion devices, membranes, solvent extraction devices, and the like. It should be understood that separation processes described in this disclosure may not completely separate all of one chemical constituent from all of another chemical constituent. It should be understood that the separation processes described in this disclosure “at least partially” separate different chemical components from one another, and that even if not explicitly stated, it should be understood that separation may include only partial separation.

As used in this disclosure, a “liquid organic hydrogen carrier,” often referred to as an “LOHC,” is a chemical compound or substance that can reversibly absorb and release hydrogen atoms from molecular hydrogen (H₂). The LOHC generally acts as a vector for storing and transporting hydrogen in a liquid form. The LOHC typically undergoes hydrogenation to store hydrogen and dehydrogenation to release it when needed. In some embodiments, LOHCs may retain and/or expel hydrogen atoms by conversion of aromatic rings into non-aromatic, cyclo-alkane moieties. Sometimes conversion of aromatic moieties to cyclo-alkane moieties may be described as “charging” of an LOHC with hydrogen, as is understood in the art. Examples of LOHCs include, without limitation, benzyltoluuene, dibenzyltoluene. n-ethylcarbazole, tetrahydronaphthalene, decalin, methylcyclohexane, diethylcyclohexane, and the like. Additionally, LOHCs are described as “hydrogen-rich” or “hydrogen-diminished” in the present disclosure. Hydrogen-rich refers to the state of the LOHC where it retains hydrogen, such as by having one or more saturated rings (i.e., cyclo-hexane moieties). Hydrogen-diminished refers to the state of an LOHC where it does not retain hydrogen, such as by having one or more aromatic moieties that may be later hydrogenated. In some embodiments, hydrogen-diminshed LOHCs may include aromatic and/or alkenyl functional groups, while hydrogen-diminished LOHCs include alkyl functionalities where these aromatic and/or alkenyl functionalities were present in the hydrogen-diminished state.

As used in this disclosure, a “catalyst” refers to any substance which increases the rate of a specific chemical reaction. Catalysts described in this disclosure may be utilized to promote various reactions, such as, but not limited to, hydrotreating reactions. As used in this disclosure, a “hydrotreating catalyst” increases the rate of a hydrotreating reaction, which may reduce sulfur, nitrogen, metals, or other substances in a process stream. Such catalysts may have dual functionality in some embodiments. The methods described herein should not necessarily be limited by specific catalytic materials. As described herein, the catalysts may be fixed in configuration and utilize gaseous reactants. However, other configurations are contemplated.

As used in this disclosure, the term “effluent” may refer to a stream that is passed out of a reactor, a reaction zone, or a separation unit following a particular reaction or separation. Generally, an effluent has a different composition than the stream that entered the separation unit, reactor, or reaction zone. It should be understood that when an effluent is passed to another system unit, only a portion of that system stream may be passed.

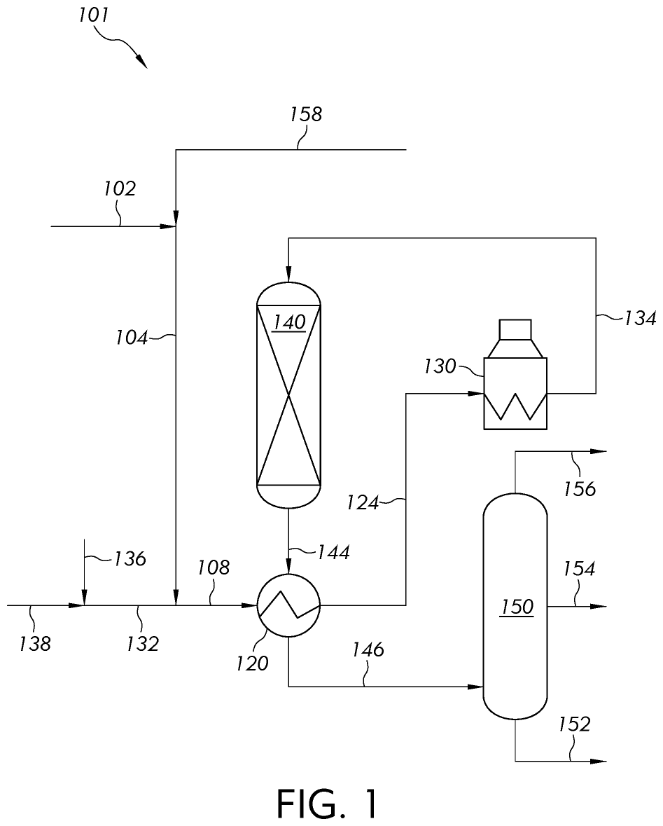

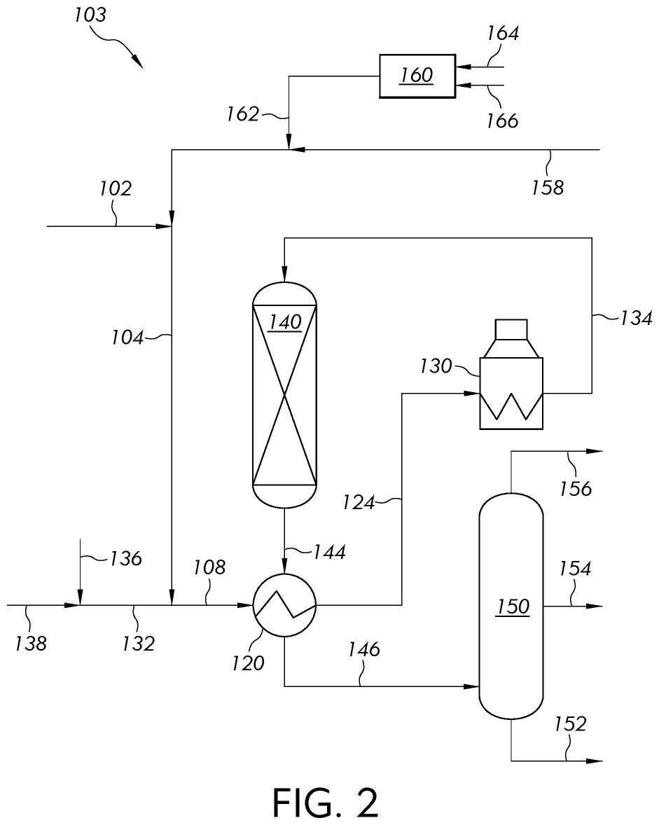

The methods for processing one or more LOHCs described herein may utilize the processing system of FIGS. 1 and/or 2. The methods are described in the context of the system of FIGS. 1 and 2, but it is contemplated that many other systems may be suitable for the methods described herein. In particular, other systems and methods than those described with respect to FIGS. 1 and 2 may be suitable, such as, without limitation, alternative separation schemes, alternative stream processing, and the ordering of the separation and/or processing steps disclosed. In particular, FIG. 1 will be described in detail herein, where various streams and processes described herein will be described in the context of the system of FIG. 1. However, the steps, streams, or other features of the disclosed methods stand independent of the system of FIG. 1, and FIG. 1 is merely provided to show one or more suitable systems as presently contemplated. Additionally, the embodiment of FIG. 2 will be described in the context of FIG. 1 where, generally, FIG. 1 and FIG. 2 may depict identical embodiments aside from where differences are discussed.

Now referring to FIG. 1, a hydrogen charging system 101 is depicted within existing refinery infrastructure, comprising a naphtha hydrotreater 140 and a separation unit 150. These system components will be described in detail herein.

According to one or more embodiments, one or more hydrogen-diminished liquid organic hydrogen carriers, a naphtha feed, and hydrogen gas may be passed to the naphtha hydrotreater 140. According to embodiments, and as shown in FIG. 1, the one or more hydrogen-diminished liquid organic hydrogen carriers may be contained in stream 138 and the naphtha feed may be contained in stream 136. Stream 136, containing the one or more hydrogen-diminished liquid organic hydrogen carriers, may be combined with stream 138, containing the naphtha feed, to form a mixed feed stream 132. Additionally, hydrogen gas may be supplied in stream 104, which may be combined with the mixed feed stream 132, to form a hydrotreater feed 108 that includes the one or more hydrogen-diminished liquid organic hydrogen carriers, a naphtha feed, and hydrogen gas. While the one or more hydrogen-diminished liquid organic hydrogen carriers, a naphtha feed, and hydrogen gas are all contained in the hydrotreater feed 108 in the embodiment of FIG. 1, it is contemplated that in additional embodiments the one or more hydrogen-diminished liquid organic hydrogen carriers, a naphtha feed, and hydrogen gas may be separately passed to the naphtha hydrotreater 140.

According to one or more embodiments, the hydrogen gas supplied to the naphtha hydrotreater via stream 104 may be a combination of recycled hydrogen in recycle hydrogen stream 158 and make-up hydrogen in make-up hydrogen stream 102. As will be described herein, the recycled hydrogen may be present in the hydrotreated effluent and separated from the hydrotreated effluent in the separation unit 150. The make-up hydrogen in steam 102 may supplement the recycled hydrogen. The hydrogen passed to the naphtha hydrotreater 140 from the hydrogen stream 102 may come from any hydrogen source, such as that produced by, for example, electrolysis by any fuel source such as fossil fuels, wind, or solar, and is described in detail hereinafter.

According to one or more embodiments, the mixed feed stream 132 may comprise 1 wt. % to 99 wt. % naphtha and 1 wt. % to 99 wt. % hydrogen-diminished LOHC. In embodiments, the mixed feed stream 132 may comprise greater than or equal to 1 wt. %, greater than or equal to 10 wt. %, greater than or equal to 20 wt. %, greater than or equal to 30 wt. %, or greater than or equal to 40 wt. % naphtha. In other embodiments, the mixed feed stream 132 comprise greater than or equal to 1 wt. %, greater than or equal to 10 wt. %, greater than or equal to 20 wt. %, greater than or equal to 30 wt. %, or greater than or equal to 40 wt. % hydrogen-diminished LOHC. It is contemplated the amount of hydrogen-diminished liquid organic hydrogen carrier and naphtha in the mixed feed stream 132 may fluctuate depending on industry need.

The hydrotreater feed may be passed to the naphtha hydrotreater 140 directly, or through one or more heating apparatuses, as is shown in FIG. 1. As depicted in FIG. 1, the hydrotreater feed 108 may be heated by passing through a heat-exchanger 120, which may pre-heat the hydrotreater feed 108 upstream of the naphtha hydrotreater 140 and form a pre-heated hydrotreater feed 124. In some embodiments, the pre-heated hydrotreater feed 124 may be further heated by a heater 130, such as a furnace, fired heater, or the like. The heater 130 may heat the pre-heated hydrotreater feed 124 to form a heated hydrotreater feed 134. It should be understood that some embodiments may not include the heat-exchanger 120, and the hydrotreater feed 108 may be passed to the heater 130 upstream of the naphtha hydrotreater 140. In embodiments that include a heat-exchanger 120, the hydrotreater feed 108 may be passed to the naphtha hydrotreater 140 via heated hydrotreater feed 134 after being heated in the heat-exchanger 120. According to additional embodiments not shown in FIG. 1, the hydrotreater feed 108 may be further heated, such as, and without limitation, by additional heat exchangers, furnaces, fired heaters, and the like before entering the naphtha hydrotreater 140.

As depicted in FIG. 1, the heated hydrotreater feed 134 may be passed to a naphtha hydrotreater 140. The naphtha hydrotreater 140 may comprise at least one hydrotreating catalyst. It is contemplated that the hydrotreating catalyst may be cobalt-molybdenum (Co—Mo), nickel-molybdenum (Ni—Mo), nickel-tungsten (Ni—W), and/or noble metal catalyst. In embodiments, the hydrotreating catalyst may be supported by alumina. The naphtha hydrotreater 140 may be operable to at least partially reduce the content of metals, sulfur, or nitrogen in the heated hydrotreater feed 134 (from the naphtha feed) to produce a hydrotreated effluent stream 144 that includes hydrotreated naphtha. For example, the hydrotreated effluent 144 passed out of the naphtha hydrotreater 140 may have a lesser amount of one or more of sulfur, metals, or nitrogen than the heated hydrotreater feed 134 by at least 25%, at least 50%, or even at least 75%.

The naphtha hydrotreater 140 may also be operable to at least partially hydrogenate the hydrogen-diminished LOHC to produce hydrogen-rich LOHC, such that the hydrotreated effluent stream includes hydrogen-rich LOHC and unreacted hydrogen (in addition to the hydrotreated naphtha). The hydrogen-diminished LOHC may be benzyltoluene. It is contemplated that benzyltoluene may be produced by the refinery where system 101 is located, such as in an aromatics complex of a refinery.

In Reaction I, benzyltoluene reacts to form perhydro benzyltoluene. This reaction may be performed with a catalyst, such as, but not limited to, the same catalysts used for the hydrotreatment of naphtha described hereinabove. For example, the catalyst may be may be cobalt-molybdenum (Co—Mo), nickel-molybdenum (Ni—Mo), nickel-tungsten (Ni—W), and/or noble metal catalysts. Without being bound by any theory, sulfide catalysts such as cobalt-molybdenum (Co—Mo) nickel-molybdenum (Ni—Mo) may be utilized because they may contain active metal sites, which are capable of promoting the hydrogenation reactions and may outperform other catalysts.

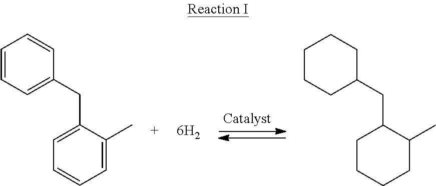

It is contemplated that an additional, unsupported catalyst may be packed at the bottom of the bed of the at least one hydrotreating catalyst. This unsupported catalyst may have hydrogenation function and comprise a mixed metal sulfide. The metal may be nickel, cobalt, molybdenum, tungsten, or a combination of these. Without being bound by any theory, the additional catalyst bed may assist in achieving higher rates of hydrogenation.

As is described herein, in embodiments, the naphtha hydrotreater 140 may operate at a temperature and pressure sufficient to hydrotreat the naphtha feed and hydrogenate the hydrogen-diminished LOHC. For example, the naphtha hydrotreater 140 may operate at a temperature of from 225° C. to 235° C., such as from 235° C. to 245° C., from 245° C. to 255° C., from 255° C. to 265° C., from 265° C. to 275° C. or any combination of these ranges. In embodiments, the naphtha hydrotreater 140 may operate at a pressure of from 2.5 MPa (25 bar) to 4.5 MPa (45 bar), such as from 2.5 mPa to 3 MPa, from 3 MPa to 3.5 MPa, from 3.5 MPa to 4 MPa, from 4 MPa to 4.5 MPa, or any combination of one or more of these ranges. Surprisingly, it has been discovered that LOHC hydrogenation and naphtha hydrotreating may be operable at about the same temperatures and pressures, allowing for the naphtha hydrotreating and LOHC dehydrogenation to take place in the same vessel while intermixed.

According to some embodiments, the catalyst to feed ratio of the heated hydrotreater feed 134 may be from 5 to 100. For example, the catalyst to feed ratio of the heated hydrotreater may be from 5 to 10, from 10 to 20, from 20 to 30, from 30 to 40, from 40 to 50, from 50 to 60, from 60 to 70, from 70 to 80, from 80 to 90, or from 90 to 100. Catalyst to feed ratio is described in weight/weight terms unless otherwise specified herein.

Following hydrotreating of the heated hydrotreater feed 134 resulting in the formation of the hydrotreated effluent 144, the hydrotreated effluent 144 may be passed to a separation unit 150. In embodiments with the heat-exchanger 120, the hydrotreated effluent 144 may be heat-exchanged with the hydrotreater feed 108 and produce a heat-exchanged hydrotreated effluent 146. It should be understood that some embodiments may not include the heat-exchanger 120, and the hydrotreated effluent 144 may be passed directly to the separation unit 150. In embodiments that include a heat-exchanger 120, the hydrotreated effluent 144 may be heat-exchanged with other streams or more than one stream. The hydrotreated effluent 144 or the heat-exchanged hydrotreated effluent 146 may be separated into at least three streams by the separation unit 150, a light products stream 156, a hydrotreated naphtha 154, and a hydrogen-rich liquid organic hydrogen carrier 152. The separation unit 150 may be any suitable separation unit, such as, and without limitation, a flash vessel or fractionator/distillation column that separates feedstock based on the boiling point at a specified cut point.

As described herein, the “cut point” in a separation generally identifies the approximate final boiling point of a lighter fraction and approximate initial boiling point of a heavier fraction based on atmospheric pressure conditions. In some embodiments, such as depicted in FIG. 1, the hydrotreated effluent 144 or the heat-exchanged hydrotreated effluent 146 is separated into the light products stream 156, the hydrotreated naphtha stream 154, and the hydrogen-rich LOHC stream 152. If other streams are produced by the separation unit 150 (besides the light products stream 156, the hydrotreated naphtha stream 154, and the hydrogen-rich LOHC stream 152), those streams may be only a relatively small portion of the hydrotreated effluent 144 or the heat-exchanged hydrotreated effluent 146. For example, at least 90 wt. %, at least 95 wt. %, at least 99 wt. %, at least 99.9 wt. %, or 100 wt. % of the hydrotreated effluent 144 or the heat-exchanged hydrotreated effluent 146 may be contained in the light products stream 156, the hydrotreated naphtha stream 154, and the hydrogen-rich LOHC stream 152.

According to embodiments, the cut point between the light products stream 156 and the hydrotreated naphtha stream 154 may be in a range of from 50° C. to 110° C. In such embodiments, the light products stream 156 may have a maximum boiling point of from 50° C. to 110° C., and the hydrotreated naphtha stream 154 may have a minimum boiling point of from 50° C. to 110° C. According to some embodiments, the cut point between the light products stream 156 and the hydrotreated naphtha stream 154 may be in a range of from 80° C. to 100° C. In such embodiments, the light products stream 156 may have a maximum boiling point of from 80° C. to 100° C. and the hydrotreated naphtha 154 may have a minimum boiling point of from 80° C. to 100° C.

According to embodiments, the cut point between the hydrotreated naphtha stream 154 and the hydrogen-rich LOHC stream 152 may be in a range of from 190° C. to 210° C. In such embodiments, the hydrotreated naphtha may have a maximum boiling point of from 190° C. to 210° C. and the hydrogen-rich LOHC 152 may have a minimum boiling point of from 190° C. to 210° C. According to some embodiments, the cut point between the hydrotreated naphtha stream 154 and the hydrogen-rich LOHC stream 152 may be in a range of from 260° C. to 280° C. In such embodiments, the hydrotreated naphtha stream 154 may have a maximum boiling point of from 260° C. to 280° C. and the hydrogen-rich LOHC stream 152 may have a minimum boiling point of from 260° C. to 280° C.

In one or more embodiments, the light products stream 156 may be passed downstream for further processing. In one or more embodiments, hydrogen may be separated from the light products stream 156 to produce the recycle hydrogen stream 158 or for use as feedstocks in other processes (e.g., pyrolysis). The hydrotreated naphtha stream 154 may be passed downstream for further processing (e.g., reforming), to form gasoline blend pool material.

The hydrogen-rich LOHC 152 may be passed downstream for storage or transportation. Such hydrogen-rich LOHC may be later hydrogenated at a different facility in a different geographic location to form hydrogen gas. As such, the hydrogen from the hydrogen stream 102 may be transported in a liquid form to its destination, rather than being transported as a compressed hydrogen gas.

Now referring to FIG. 2, another hydrogen charging system 103 is depicted. The hydrogen charging system 103 may be similar or identical to the hydrogen charging system 101 of FIG. 1 except where described otherwise. In particular, the hydrogen charging system 103 may utilize hydrogen from different sources such as those that emit carbon during formation of the hydrogen gas and those that do not emit carbon during the formation of the hydrogen gas.

According to one or more embodiments, hydrogen stream 162 may represent a first hydrogen gas portion and hydrogen stream 102 may represent a second hydrogen gas portion. As recycle hydrogen stream 158 may be unreacted hydrogen recovered from the hydrotreated effluent 144, the first hydrogen gas portion and second hydrogen gas portion may account for all hydrogen entering the hydrogen charging system 103. According to one or more embodiments, the first hydrogen gas portion in hydrogen stream 162 may be hydrogen produced by a method with no direct carbon emissions to the atmosphere, and the second hydrogen gas portion in hydrogen stream 162 may be hydrogen produced by a method with direct carbon emissions to the atmosphere. Direct carbon emissions generally refers to carbon, such as in the form of carbon dioxide, that is emitted to the environment (not sequestered) in a process that produces hydrogen, such as from the released of carbon dioxide from fossil fuels during hydrogen production.

Hydrogen may be produced by a wide variety of methods and resources. Based on environmental sustainability, some hydrogen may be more valuable based on its origin and production means. For example, hydrogen that is produced with little or no carbon emission may be more valuable in the marketplace. These include the first, second, and third hydrogen production methods described hereinbelow, which produce hydrogen with no direct carbon emissions, as well as hydrogen that is naturally occurring (sometimes referred to as “white hydrogen” in industry).

A first hydrogen generation technique includes a water electrolysis process by employing renewable electricity (sometimes referred to as “green hydrogen” in industry). Generally, there is no carbon dioxide emissions during this production technique. Renewable electricity may be generated from, without limitation, wind, solar, geothermal, hydroelectric, marine, biomass, and other forms of electricity produced from renewable resources that do not contribute to carbon emissions.

A second hydrogen generation technique includes producing hydrogen by utilization of fossil fuels, but the generated carbon dioxide is captured and sequestered, such as sequestered underground (sometimes referred to as “blue hydrogen” in industry). Since no carbon is emitted into the air, this is considered as carbon neutral in industry.

A third hydrogen generation technique includes extracting energy from nuclear reactions, where in general carbon dioxide is not emitted. Several techniques are known for forming hydrogen from nuclear fission and/or fusion, including hydrogen that is made though using nuclear power and heat through combined chemo thermal electrolysis splitting of water (sometimes referred to as “purple hydrogen” in industry); hydrogen that is generated through electrolysis of water by using electricity from a nuclear power plant (sometimes referred to as “pink hydrogen” in industry); and hydrogen that is produced through the high-temperature catalytic splitting of water using nuclear power thermal as an energy source (sometimes referred to as “red hydrogen” in industry).

Other sources of hydrogen production produce carbon emissions that are not sequestered. These include, without limitation, hydrogen is produced from fossil fuel and commonly uses steam methane reforming (SMR) method (sometimes referred to as “gray hydrogen” in industry), hydrogen is produced from coal, usually by gasification (sometimes referred to as “black hydrogen” or “brown hydrogen” in industry).

As described herein, the hydrogen atoms that are stored in the hydrogen-rich liquid organic hydrogen carriers may be later converted to hydrogen gas via dehydrogenation. In some embodiments, it may be desirable to have the hydrogen gas that is recovered from the hydrogen-rich liquid organic hydrogen carriers to be marketable as hydrogen that is produced by methods with no direct carbon emissions to the atmosphere (e.g., green hydrogen, blue hydrogen, white hydrogen, purple hydrogen, pink hydrogen, or red hydrogen). In such embodiments, this may be achieved by passing an amount of the first hydrogen gas portion (e.g., renewably sourced hydrogen) to the hydrotreater that is greater than or equal to the amount of hydrogen that is reacted with the one or more hydrogen-diminished liquid organic hydrogen carriers to form the one or more hydrogen-rich liquid organic hydrogen carriers. In such embodiments, the hydrogen atoms present in the hydrogen-rich liquid organic hydrogen carriers and later formed as hydrogen gas are theoretically hydrogen that does not produce carbon. Such hydrogen gas product may be more valuable on the market than traditionally sourced hydrogen gas formed by gasification of fossil fuels.

Referring still to FIG. 2, a water electrolysis unit 160 is depicted that forms hydrogen stream 162. In such embodiments, water 164 and renewable electricity 166 may be passed to the water electrolysis unit 160. As described herein, water electrolysis is only one method by which the first hydrogen gas portion may be produced, and other equipment and inputs may be utilized instead of the water electrolysis unit 160 depending on the hydrogen production technique employed (e.g., green hydrogen, blue hydrogen, white hydrogen, purple hydrogen, pink hydrogen, or red hydrogen).

The present disclosure includes multiple aspects. A first aspect is a method for processing one or more liquid organic hydrogen carriers, the method comprising: introducing a hydrotreater feed comprising one or more hydrogen-diminished liquid organic hydrogen carriers, a naphtha feed, and hydrogen gas into a naphtha hydrotreater to form a hydrotreated effluent, wherein in the naphtha hydrotreater: the one or more hydrogen-diminished liquid organic hydrogen carriers and hydrogen gas react to form one or more hydrogen-rich liquid organic hydrogen carriers; and the naphtha feed reacts to form a hydrotreated naphtha; passing the hydrotreated effluent from the naphtha hydrotreater to a separation unit, wherein the hydrotreated effluent comprises the one or more hydrogen-rich liquid organic hydrogen carriers, the hydrotreated naphtha, and unreacted hydrogen; and in the separation unit, separating at least the one or more hydrogen-rich liquid organic hydrogen carriers from the hydrotreated naphtha.

A second aspect of the present disclosure may include the first aspect, wherein the one or more hydrogen-diminished liquid organic hydrogen carriers comprise benzyl toluene and the one or more hydrogen-rich liquid organic hydrogen carriers comprise perhydro benzyl toluene.

A third aspect of the present disclosure may include any of the previous aspects, wherein the hydrotreated naphtha has a minimum boiling point in a range of from 80° C. to 100° C. and a maximum boiling point of from 190° C. to 210° C.

A fourth aspect of the present disclosure may include any of the previous aspects, wherein at least one of the hydrogen-rich liquid organic hydrogen carriers has a boiling point of from 260° C. to 280° C.

A fifth aspect of the present disclosure may include any of the previous aspects, further comprising separating light gas from the hydrotreated naphtha and the at least one hydrogen-rich liquid organic hydrogen carriers in the separation unit.

A sixth aspect of the present disclosure may include the fifth aspect, further comprising separating hydrogen from the light gas to produce a recycled hydrogen stream.

A seventh aspect of the present disclosure may include the sixth aspect, wherein the recycled hydrogen stream is a portion of the hydrogen gas passed to the naphtha hydrotreater.

An eighth aspect of the present disclosure may include any of the previous aspects, wherein a hydrogen gas introduced to the hydrotreater comprises a first hydrogen gas portion and a second of hydrogen gas portion, wherein the first hydrogen gas portion is hydrogen produced by a method with no direct carbon emissions to the atmosphere and the second hydrogen gas portion is hydrogen produced by a method with direct carbon emissions to the atmosphere

A ninth aspect of the present disclosure may include the eighth aspect, wherein the method to produce the first hydrogen gas portion comprises utilization of renewable electricity.

A tenth aspect of the present disclosure may include the eighth aspect, wherein the method to produce the first hydrogen gas portion comprises utilization of fossil fuels and sequestration of a produced carbon.

An eleventh aspect of the present disclosure may include the eighth aspect, wherein the method to produce the first hydrogen gas portion comprises utilization of nuclear fission or fusion.

A twelfth aspect of the present disclosure may include the eighth aspect, wherein the amount of the first hydrogen gas portion passed to the hydrotreater is greater than or equal to the amount of hydrogen that is reacted with the one or more hydrogen-diminished liquid organic hydrogen carriers to form the one or more hydrogen-rich liquid organic hydrogen carriers.

A thirteenth aspect of the present disclosure may include any of the previous aspects, further comprising further comprising producing the first hydrogen gas portion by the method with no direct carbon emissions to the atmosphere.

A fourteenth aspect of the present disclosure may include the thirteenth aspect, wherein producing the first hydrogen gas portion by the method with no direct carbon emissions to the atmosphere comprises electrolysis of water.

A fifteenth aspect of the present disclosure may include any of the previous aspects, further comprising producing the second hydrogen gas portion by the method with direct carbon emissions to the atmosphere.

A sixteenth aspect of the present disclosure may include any of the previous aspects, wherein the naphtha hydrotreater comprises one or more hydrotreating catalysts.

A seventeenth aspect of the present disclosure may include any of the previous aspects, further comprising heat-exchanging the hydrotreater feed and the hydrotreated effluent.

An eighteenth aspect of the present disclosure may include the seventeenth aspect, further comprising heating the hydrotreater feed by a furnace upstream of the naphtha hydrotreater.

A nineteenth aspect of the present disclosure may include any of the previous aspects, further comprising heating the hydrotreater feed by a furnace upstream of the naphtha hydrotreater.

A twentieth aspect of the present disclosure may include any of the previous aspects, wherein the hydrotreated naphtha has a lesser amount of one or more of sulfur, metals, or nitrogen than the naphtha feed.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that any two quantitative values assigned to a property may constitute a range of that property, and all combinations of ranges formed from all stated quantitative values of a given property are contemplated in this disclosure. It should be appreciated that compositional ranges of a chemical constituent in a composition should be appreciated as containing, in some embodiments, a mixture of isomers of that constituent. In additional embodiments, the chemical compounds may be present in alternative forms such as derivatives, salts, hydroxides, etc.

It is also noted that recitations herein of “at least one” component, element, etc., should not be used to create an inference that the alternative use of the articles “a” or “an” should be limited to a single component, element, etc.

It should further be understood that streams may be named for the components of the stream, and the component for which the stream is named may be the major component of the stream (such as comprising from 50 weight percent (wt. %), from 70 wt. %, from 90 wt. %, from 95 wt. %, from 99 wt. %, from 99.5 wt. %, or even from 99.9 wt. % of the contents of the stream to 100 wt. % of the contents of the stream). It should also be understood that components of a stream are disclosed as passing from one system component to another when a stream comprising that component is disclosed as passing from that system component to another. For example, a disclosed “naphtha stream” passing from a first system component to a second system component should be understood to equivalently disclose “naphtha” passing from a first system component to a second system component, and the like.

What is claimed is:

1. A method for processing one or more liquid organic hydrogen carriers, the method comprising:
introducing a hydrotreater feed comprising one or more hydrogen-diminished liquid organic hydrogen carriers, a naphtha feed, and hydrogen gas into a naphtha hydrotreater to form a hydrotreated effluent, wherein in the naphtha hydrotreater:
the one or more hydrogen-diminished liquid organic hydrogen carriers and hydrogen gas react to form one or more hydrogen-rich liquid organic hydrogen carriers; and
the naphtha feed reacts to form a hydrotreated naphtha;
passing the hydrotreated effluent from the naphtha hydrotreater to a separation unit, wherein the hydrotreated effluent comprises the one or more hydrogen-rich liquid organic hydrogen carriers, the hydrotreated naphtha, and unreacted hydrogen; and
in the separation unit, separating at least the one or more hydrogen-rich liquid organic hydrogen carriers from the hydrotreated naphtha.

2. The method of claim 1, wherein the one or more hydrogen-diminished liquid organic hydrogen carriers comprise benzyl toluene and the one or more hydrogen-rich liquid organic hydrogen carriers comprise perhydro benzyl toluene.

3. The method of claim 1, wherein the hydrotreated naphtha has a minimum boiling point in a range of from 80° C. to 100° C. and a maximum boiling point of from 190° C. to 210° C.

4. The method of claim 1, wherein at least one of the hydrogen-rich liquid organic hydrogen carriers has a boiling point of from 260° C. to 280° C.

5. The method of claim 1, further comprising separating light gas from the hydrotreated naphtha and the at least one hydrogen-rich liquid organic hydrogen carriers in the separation unit.

6. The method of claim 5, further comprising separating hydrogen from the light gas to produce a recycled hydrogen stream.

7. The method of claim 6, wherein the recycled hydrogen stream is a portion of the hydrogen gas passed to the naphtha hydrotreater.

8. The method of claim 1, wherein a hydrogen gas introduced to the hydrotreater comprises a first hydrogen gas portion and a second of hydrogen gas portion, wherein the first hydrogen gas portion is hydrogen produced by a method with no direct carbon emissions to the atmosphere and the second hydrogen gas portion is hydrogen produced by a method with direct carbon emissions to the atmosphere.

9. The method of claim 8, wherein the method to produce the first hydrogen gas portion comprises utilization of renewable electricity.

10. The method of claim 8, wherein the method to produce the first hydrogen gas portion comprises utilization of fossil fuels and sequestration of a produced carbon.

11. The method of claim 8, wherein the method to produce the first hydrogen gas portion comprises utilization of nuclear fission or fusion.

12. The method of claim 8, wherein the amount of the first hydrogen gas portion passed to the hydrotreater is greater than or equal to the amount of hydrogen that is reacted with the one or more hydrogen-diminished liquid organic hydrogen carriers to form the one or more hydrogen-rich liquid organic hydrogen carriers.

13. The method of claim 1, further comprising further comprising producing the first hydrogen gas portion by the method with no direct carbon emissions to the atmosphere.

14. The method of claim 13, wherein producing the first hydrogen gas portion by the method with no direct carbon emissions to the atmosphere comprises electrolysis of water.

15. The method of claim 1, further comprising producing the second hydrogen gas portion by the method with direct carbon emissions to the atmosphere.

16. The method of claim 1, wherein the naphtha hydrotreater comprises one or more hydrotreating catalysts.

17. The method of claim 1, further comprising heat-exchanging the hydrotreater feed and the hydrotreated effluent.

18. The method of claim 17, further comprising heating the hydrotreater feed by a furnace upstream of the naphtha hydrotreater.

19. The method of claim 1, further comprising heating the hydrotreater feed by a furnace upstream of the naphtha hydrotreater.

20. The method of claim 1, wherein the hydrotreated naphtha has a lesser amount of one or more of sulfur, metals, or nitrogen than the naphtha feed.
